(19) United States
(12) Patent Application Publication
(10) Pub. No.: US 2026/0071565 A1
(43) Pub. Date: Mar. 12, 2026

(54) HOT SCR TEMPERING AIR SYSTEM FOR GAS TURBINE PART LOAD EFFICIENCY AND EXTENDED TURNDOWN

(71) Applicant: GE Infrastructure Technology LLC, Greenville, SC (US)

(72) Inventor: Bradly Aaron KIPPEL, Greenville, SC (US)

(21) Appl. No.: 18/826,523

(22) Filed: Sep. 6, 2024

(51) Int. Cl. F01N 3/20; F02C 7/057

(52) U.S. Cl. CPC F01N 3/2066; F02C 7/057

(57) ABSTRACT

The present application provides a method of increasing efficiency or extending a turndown range of a gas turbine engine when an output of the gas turbine engine is to be reduced by a predetermined percentage in part load operation. The method may include the steps of closing a number of inlet guide vanes to reduce an airflow to a compressor of the gas turbine engine, turning on a standby or lag fan of a tempering air system of a selective catalytic reduction system coupled to the gas turbine engine, wherein the standby or lag fan reduces the output of the gas turbine engine by at least part of the predetermined percentage, and reopening the inlet guide vanes to increase the airflow to the compressor.

### TECHNICAL FIELD

The present application and the resultant patent relate generally to gas turbine engines and more particularly relate to a tempering air system for a selective catalytic reduction system that may improve part-load efficiency and provide extended turndown capability.

### BACKGROUND

In the combustion process of a gas turbine engine, nitrogen oxides and other types of regulated emissions are produced. Specifically, a gas turbine emits hot flue gases that often contain unacceptable levels of nitrogen oxides. One solution for reducing the overall levels of nitrogen oxide emissions is the use of a selective catalytic reduction (“SCR”) system. Generally described, the SCR system adds a reductant, typically ammonia or urea, to the hot combustion gas stream before passing the combustion gas stream through a catalyst bed so as to absorb selectively the nitrogen oxides and the reducing agent. The absorbed components undergo a chemical reaction on the catalyst surface and the reaction products are desorbed. Specifically, the reactant reacts with the nitrogen oxides in the combustion gas stream to form water and nitrogen.

The overall efficiency of the SCR system may depend at least in part on the temperature of the hot combustion gas stream. Specifically, the efficient temperature range of the SCR system may be relatively narrow. As such, the hot combustion gas stream generally should be sufficiently cooled before reaching the catalyst bed. The SCR system thus may use a tempering air system to reduce the temperature of the hot combustion gas stream with the introduction of ambient air and the like before the stream reaches the catalyst.

Operators of gas turbine engines seek the maximum output and efficiency from the engines. Maximum output and efficiency typically occur when operating at baseload. During baseload operation, the majority of the compressed air from the compressor section is combusted and the inlet guide vanes (IGVs) are fully opened so as to allow the compressor to draw in the maximum amount of air from the ambient environment. Baseload operation, however, is not always feasible. There may not be a sufficient demand in the energy market (electrical grid and the like) for all of the energy generated at baseload. The power plant must either shutdown or operate at so called “part-load” conditions (also referred herein simply as “part load”), where less than the maximum amount of energy is generated.

Gas turbine engines are typically required to maintain emissions compliance while generating power. A gas turbine engine operating at part-load, may not maintain emissions compliance over the entire part-load range. A turndown range may be considered the loading range where the gas turbine engine maintains emissions compliance. A broad turndown range allows operators to maintain emissions compliance, minimize fuel consumption, and avoid the thermal transients associated with shutting down the power plant.

### SUMMARY

The present application and the resultant patent thus provide a method of increasing efficiency or extending a turndown range of a gas turbine engine when an output of the gas turbine engine is to be reduced by a predetermined percentage in part-load operation. The method may include the steps of closing a number of inlet guide vanes to reduce an airflow to a compressor of the gas turbine engine, turning on a standby or lag fan of a tempering air system of a selective catalytic reduction system, wherein the standby or lag fan reduces the output of the gas turbine engine by at least part of the predetermined percentage, and reopening the number of inlet guide vanes to increase the airflow to the compressor.

The present application and the resultant patent further provide a gas turbine engine. The gas turbine engine includes a compressor with a number of inlet guide vanes, a combustor fluidly coupled to the compressor, a turbine fluidly coupled to the combustor, and a selective catalytic reduction system downstream of and fluidly coupled to the turbine, the selective catalytic reduction system having one or more standby or lag fans. Turning on the one or more standby or lag fans allows the inlet guide vanes to remain in an open position, or more open position, when the gas turbine engine is in part-load operation.

The present application and the resultant patent further provide a method of increasing efficiency or extending a turndown range of a gas turbine engine. The method includes the steps of reducing an output of the gas turbine engine by a predetermined percentage in part-load operation and turning on a standby or lag fan of a tempering air system of a selective catalytic reduction system. The standby or lag fan reduces the output of the gas turbine engine by at least part of the predetermined percentage.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, a combustor, a turbine, and an example of a selective catalytic reduction system.

FIG. 2 is a flow chart showing exemplary method steps in using standby or lag fans of a tempering air system to improve overall gas turbine efficiency at part-load or to extend gas turbine engine turndown range.

FIG. 3 is a flow chart showing exemplary method steps in using standby or lag fans of a tempering air system to extend gas turbine engine turndown range.

### DETAILED DESCRIPTION

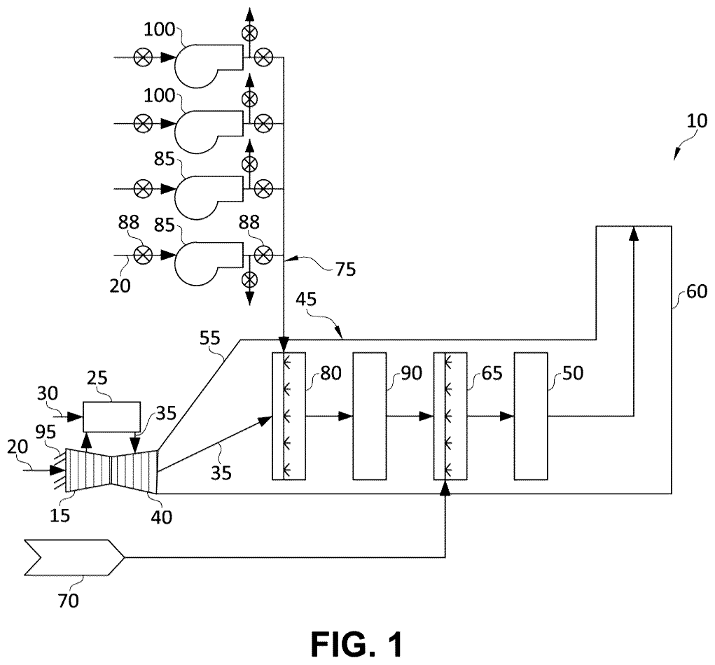

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25 positioned in a circumferential array and the like. The flow of combustion gases 35 is in turn delivered to a turbine 40 (e.g., an expansion turbine). The flow of combustion gases 35 drives the turbine 40 so as to produce mechanical work. The mechanical work produced in the turbine 40 drives the compressor 15 via a shaft, which is coupled to an external load such as an electrical generator and the like.

The gas turbine engine 10 may use natural gas, various types of syngas, liquid fuels, and/or other types of fuels and blends thereof. The gas turbine engine 10 may be any one of a number of different gas turbine engines offered by GE Vernova of Greenville, South Carolina, including, but not limited to, a 7-series or a 9-series heavy duty gas turbine engine and the like. The gas turbine engine 10 may be part of a simple cycle power generation system or other types of generation systems. The gas turbine engine 10 may have different configurations and may use other types of components. Other types of gas turbine engines also may be used herein. Multiple gas turbine engines, other types of turbines, and other types of power generation equipment also may be used herein together.

The gas turbine engine 10 also may include a SCR system 45. The SCR system 45 may be positioned downstream of the turbine 40. As described above, the SCR system 45 may include a catalyst 50 therein to react with the combustion gas stream 35. The catalyst 50 may be of conventional design and may be manufactured from suitable carrier and active catalytic components. Different types of catalysts 50 may be used herein. The catalyst 50 may have any suitable size, shape, or configuration. The SCR system 45 may extend from an inlet 55 to a stack 60 or other type of exhaust. An ammonia injection grid 65 may be positioned near the catalyst 50 to inject a reductant such as ammonia into the combustion gas stream 35. The ammonia injection grid 65 may be in communication with an ammonia source 70. The ammonia injection grid 65 may be in communication with the ammonia source 70 via an extensive piping system to produce an adequate ammonia distribution into the incoming combustion gas stream 35. The stack 60 or other type of exhaust may be positioned downstream of the catalyst 50.

The SCR system 45 also may include a tempering air system 75. The tempering air system 75 may reduce the temperature of the combustion gas stream 35 with the introduction of ambient air 20 and the like before the stream 35 reaches the catalyst 50. The tempering air system 75 may include a tempering air grid 80 positioned near the inlet 55 of the SCR system 45 and upstream of the ammonia injection grid 65 and the catalyst 50. The tempering air grid 80 may be in communication with a source of ambient air 20 via one or more tempering air fans 85 or other type of air movement device. Each tempering air fan 85 may have a damper 88 on the fan entrance and/or exit. The dampers 88 may include a valve, a plate, blades, and the like to moderate or stop the air flow therethrough as desired. The dampers 88 may be closed until the tempering air fans 85 spool up and develop a sufficient pressure and volume to prevent blowback therethrough.

A gas mixer 90 may be positioned downstream of the tempering air grid 80. The gas mixer 90 also may include a series of baffles and the like. The gas mixer 90 may mix the incoming combustion gas stream 35 and the ambient air 20 to obtain an adequate temperature distribution therein. The now-cooled flow then may flow past the ammonia injection grid 65 and the catalyst 50 for reaction therewith. The SCR system 45 described herein is for the purpose of example only. Many other types of SCR systems and components may be used herein.

The SCR system 45 generally will have some level of redundancy with respect to the tempering air fans 85. The tempering air fans 85 may be arranged as a two by 100% arrangement, a three by 50% arrangement, a four by 33% arrangement, and the like with at least one standby or lag fan 100. In the exemplary system of FIG. 1, a four by 50% arrangement is shown. On an advanced gas turbine engine 10, the size of the fan motors may be in excess of one megawatt or more. In a known two by 100% arrangement, the standby or lag fan 100 may be as large as six megawatts or more. Variable size and speed motors and fans also may be used together herein. Motors and fans of differing speeds also may be used. Turning on a standby or lag fan 100 reduces the net output of the gas turbine engine 10 accordingly, i.e., turning on a five megawatt standby or lag fan 100 reduces the net output of the gas turbine engine 10 by five megawatts. If more than one standby or lag fan 100 is used simultaneously, the parasitic losses are corresponding increased. The standby or lag fan(s) 100 may be provided with dampers 88, which function as described above.

The compressor 15 may include a number of inlet guide vanes 95 positioned about an inlet thereof. Generally described, the output (electrical, mechanical, or the like) of the gas turbine engine 10 is governed by the amount of mass-flow entering the compressor 15. The mass-flow may be considered the product of the density and the volume-flow of the inlet air 20 entering the compressor 15. The amount of volume-flow entering the compressor 15 may vary on the ambient temperature conditions and the angle of inlet guide vanes 95. The angle of the inlet guide vanes 95 may determine the flow area at the inlet of the compressor 15. The angle of the inlet guide vanes 95 may be reduced to a minimum angle, limiting the amount of turndown. At the minimum angle, a corresponding minimum volume-flow is drawn into the compressor 15. Likewise at the maximum angle, a corresponding maximum volume-flow is drawn into the compressor 15.

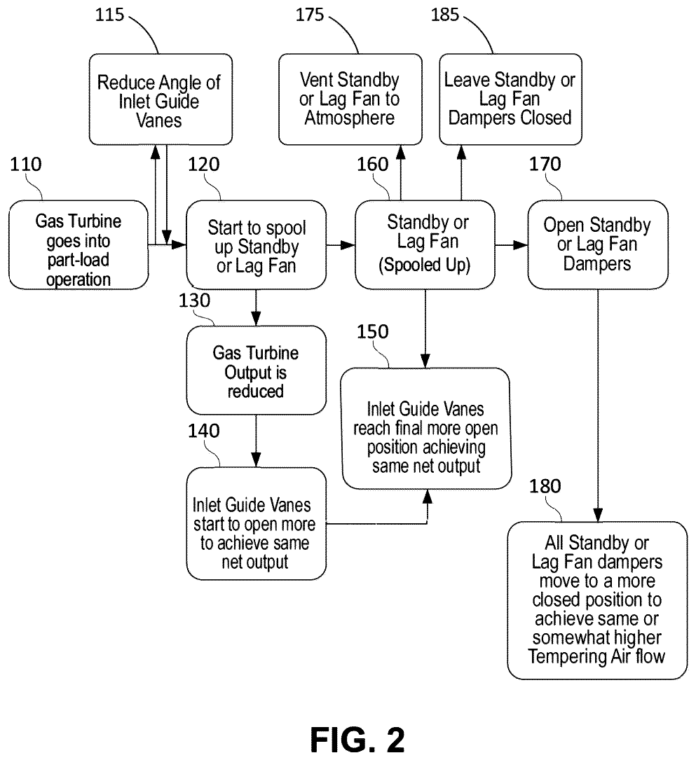

FIG. 2 shows a flow chart of exemplary method steps in using the standby or lag fans 100 to increase the overall efficiency of the gas turbine engine 10 in part-load operation or to extend the overall turndown range of the gas turbine engine 10. As described above, turning on the standby or lag fans 100 reduces the output of the gas turbine engine 10 accordingly due to the energy consumed by the standby or lag fans 100. This reduced output allows the inlet guide vanes 95 to be opened up so as to improve efficiency of the gas turbine engine 10 with resulting lower fuel consumption. Alternatively, the reduced output may extend the turndown range of the gas turbine engine 10.

For example, the baseload output of the gas turbine engine 10 may be 100× and each standby or lag fan 100 may be sized at 5×. In step 110, the gas turbine engine 10 may be moved into part-load operation. In other words, the overall power demand may be decreased by a predetermined percentage, for example, five percent, such that the output of the gas turbine engine should be reduced to 95×. As a result, the angle of the inlet guide vanes 95 must be reduced (moved to a more closed position) to accommodate part-load operation at step 115. At step 120, one of the standby or lag fans 100 may be turned on and start to spool up. The damper 88 on the standby or lag fans 100 may be closed before turning on the standby or lag fans 100. At step 130, the output of the gas turbine engine 10 is reduced by 5× to power the standby or lag fan 100. At step 140, the angle of the inlet guide vanes 95 may be increased (moved to a more open position) to achieve the same net output. At step 150, the inlet guide vanes 95 thus return to the more open position as in baseload to achieve this same net output. At step 160, the standby or lag fan 100 may be fully spooled up. Dampers 88, which may have been closed before the standby or lag fan 100 was turned on, are maintained in a closed position during spool up. At optional step 170, once the standby or lag fan 100 is fully on-line, the damper 88 on the standby or lag fan 100 may be opened. At optional step 180, the dampers 88 on all or some of the tempering air fans 85 and the standby or lag fan 100 may be moved to a more closed position to achieve the same or somewhat higher overall tempering air flow as in baseload operations. These steps may be reversed at least in part when the gas turbine engine 10 returns to baseload operations.

Instead of using the dampers 88 on the standby or lag fans 100, the airflow therethrough may be vented to the atmosphere or to other uses instead of the SCR system 45 in optional step 175. Likewise, the dampers 88 on the standby or lag fans 100 may remain closed at all times in optional step 185, in which the method of FIG. 2 would omit steps 170 and 180 and the flow through the standby or lag fans 100 would be vented to the atmosphere. Additional standby or lag fans 100 may be turned on if the predetermined percentage of the part-load operation increases or otherwise changes. Standby or lag fans 100 of differing sizes or variable speeds or capacities may be used together to more closely accommodate the predetermined percentage of the part-load operations.

The use of the standby or lag fans 100 thus increases the efficiency of the gas turbine engine 10 during part-load operations as well as extends the overall turndown range. Any number of the standby or lag fans 100 may be used together depending upon the desired extent of part-load operations. Moreover, given that standard SCR systems require redundancy in the tempering air systems, this overall increase in efficiency may be provided without additional capital investment.

In addition to the standby or lag fans 100 of the tempering air system 75, other types of auxiliary and/or parasitic systems also may be brought on-line to reduce the overall output of the gas turbine engine 10. Few other components, however, have a significant auxiliary load and/or can be run without some sort of harm to the system.

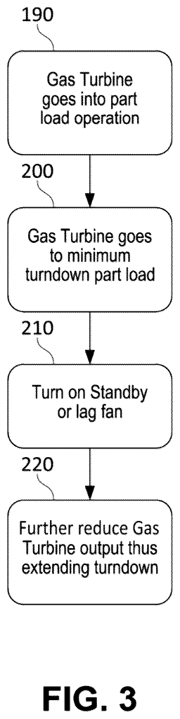

FIG. 3 is a further flowchart showing exemplary method steps in extending the turndown range of the gas turbine engine 10. At step 190, the gas turbine engine 10 moves into part-load operation. At step 200, the gas turbine engine 10 reaches a minimum part-load turndown. At step 210, the standby or lag fan(s) 100 are turned on. At step 220, turning on the standby or lag fan(s) 100 further reduces the output of the gas turbine engine 10 thus further extending the turndown range. These steps may be performed in series or in parallel.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

Further aspects of this invention are provided by the subject matter of the following clauses:
1. A method of increasing efficiency or extending a turndown range of a gas turbine engine when an output of the gas turbine engine is to be reduced by a predetermined percentage in part-load operation, comprising closing a plurality of inlet guide vanes to reduce an airflow to a compressor of the gas turbine engine; turning on a standby or lag fan of a tempering air system of a selective catalytic reduction system coupled to the gas turbine engine; wherein the standby or lag fan reduces the output of the gas turbine engine by at least part of the predetermined percentage; and reopening the plurality of inlet guide vanes to increase the airflow to the compressor.
2. The method of any preceding clause, further comprising the step of turning on an additional standby or lag fan if the predetermined percentage increases.
3. The method of any preceding clause, further comprising the step of turning on a plurality of standby or lag fans.
4. The method of any preceding clause, wherein the step of turning on a plurality of standby or lag fans comprises turning on a plurality of differently sized standby or lag fans.
5. The method of any preceding clause, wherein the step of turning on a standby or lag fan comprises turning on a variable speed standby or lag fan.
6. The method of any preceding clause, further comprising the step of closing a damper on the standby or lag fan before turning on the standby or lag fan.
7. The method of any preceding clause, further the step of comprising maintaining the damper in a closed position while the standby or lag fan spools up.
8. The method of any preceding clause, further comprising the step of opening the damper on the standby or lag fan at least in part once the standby or lag fan spools up.
9. The method of any preceding clause, further comprising the step of providing a plurality of tempering air fans with dampers thereon and further comprising the step of closing in part the dampers of the plurality of tempering air fans and the standby or lag fan.
10. The method of any preceding clause, further comprising the step of turning off the standby or lag fan once part-load operation ends.
11. A gas turbine engine, comprising: a compressor comprising a plurality of inlet guide vanes; a combustor fluidly coupled to the compressor; a turbine fluidly coupled to the turbine; and a selective catalytic reduction system downstream of and fluidly coupled to the turbine, the selective catalytic reduction system comprising one or more standby or lag fans; wherein turning on the one or more standby or lag fans allows the plurality of inlet guide vanes to remain in an open position when the gas turbine engine is in part-load operation.
12. The gas turbine engine of any preceding clause, wherein the one or more standby or lag fans are part of a tempering air system.
13. The gas turbine engine of c any preceding clause, wherein the one or more standby or lag fans comprise a damper thereon.
14. The gas turbine engine of any preceding clause, wherein the one or more standby or lag fans comprise a plurality of differently sized fans.
15. The gas turbine engine of any preceding clause, wherein the open position comprises an at least partially open position.
16. A method of increasing efficiency or extending a turndown range of a gas turbine engine, the method comprising: reducing an output of the gas turbine engine by a predetermined percentage in part-load operation; and turning on a standby or lag fan of a tempering air system of a selective catalytic reduction system; wherein the standby or lag fan reduces the output of the gas turbine engine by at least part of the predetermined percentage.
17. The method of any preceding clause, further comprising the step of maintaining a plurality of inlet guide vanes in at least a partially open position to maintain an airflow to a compressor of the gas turbine engine when the standby or lag fan is turned on.
18. The method of any preceding clause, further comprising the step of closing a plurality of inlet guide vanes to reduce an airflow to a compressor of the gas turbine engine before the standby or lag fan is turned on.
19. The method of any preceding clause, further the step of comprising reopening the plurality of inlet guide vanes to increase the airflow to the compressor once the standby or lag fan is turned on.
20. The method of any preceding clause, further comprising the step of venting air of the standby or lag fan to the atmosphere.

1. A method of increasing efficiency or extending a turndown range of a gas turbine engine when an output of the gas turbine engine is to be reduced by a predetermined percentage in part-load operation, comprising:
closing a plurality of inlet guide vanes to reduce an airflow to a compressor of the gas turbine engine;
turning on a standby or lag fan of a tempering air system of a selective catalytic reduction system coupled to the gas turbine engine;
wherein the standby or lag fan reduces the output of the gas turbine engine by at least part of the predetermined percentage; and
reopening the plurality of inlet guide vanes to increase the airflow to the compressor.

2. The method of claim 1, further comprising the step of turning on an additional standby or lag fan if the predetermined percentage increases.

3. The method of claim 1, further comprising the step of turning on a plurality of standby or lag fans.

4. The method of claim 3, wherein the step of turning on a plurality of standby or lag fans comprises turning on a plurality of differently sized standby or lag fans.

5. The method of claim 1, wherein the step of turning on a standby or lag fan comprises turning on a variable speed standby or lag fan.

6. The method of claim 1, further comprising the step of closing a damper on the standby or lag fan before turning on the standby or lag fan.

7. The method of claim 6, further comprising the step of maintaining the damper in a closed position while the standby or lag fan spools up.

8. The method of claim 7, further comprising the step of opening the damper on the standby or lag fan at least in part once the standby or lag fan spools up.

9. The method of claim 8, further comprising providing a plurality of tempering air fans with dampers thereon and further comprising the step of closing in part the dampers of the plurality of tempering air fans and the standby or lag fan.

10. The method of claim 1, further comprising the step of turning off the standby or lag fan once part load operation ends.

11. A gas turbine engine, comprising:
a compressor comprising a plurality of inlet guide vanes;
a combustor fluidly coupled to the compressor;
a turbine fluidly coupled to the combustor; and
a selective catalytic reduction system downstream of and fluidly coupled to the turbine;
the selective catalytic reduction system comprising one or more standby or lag fans;
wherein turning on the one or more standby or lag fans allows the plurality of inlet guide vanes to remain in an open position when the gas turbine engine is in part-load operation.

12. The gas turbine engine of claim 11, wherein the one or more standby or lag fans are part of a tempering air system.

13. The gas turbine engine of claim 11, wherein the one or more standby or lag fans comprise a damper thereon.

14. The gas turbine engine of claim 11, wherein the one or more standby or lag fans comprise a plurality of differently sized fans.

15. The gas turbine engine of claim 11, wherein the open position comprises an at least partially open position.

16. A method of increasing efficiency or extending a turndown range of a gas turbine engine, the method comprising:
reducing an output of the gas turbine engine by a predetermined percentage in part-load operation; and
turning on a standby or lag fan of a tempering air system of a selective catalytic reduction system;
wherein the standby or lag fan reduces the output of the gas turbine engine by at least part of the predetermined percentage.

17. The method of claim 16, further comprising the step of maintaining a plurality of inlet guide vanes in at least a partially open position to maintain an airflow to a compressor of the gas turbine engine when the standby or lag fan is turned on.

18. The method of claim 16, further comprising the step of closing a plurality of inlet guide vanes to reduce an airflow to a compressor of the gas turbine engine before the standby or lag fan is turned on.

19. The method of claim 18, further comprising the step of reopening the plurality of inlet guide vanes to increase the airflow to the compressor once the standby or lag fan is turned on.

20. The method of claim 16, further comprising the step of venting air of the standby or lag fan to the atmosphere.
